(19) United States
(12) Patent Application Publication
(10) Pub. No.: US 2007/0219914 A1
(43) Pub. Date: Sep. 20, 2007

(54) Document-based civilly-catastrophic event personal action guide facilitation method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/383,022

(22) Filed: May 12, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.
(63) Continuation-in-part of application No. 11/381,247, filed on May 2, 2006.
(63) Continuation-in-part of application No. 11/381,257, filed on May 2, 2006.
(63) Continuation-in-part of application No. 11/381,265, filed on May 2, 2006.
(63) Continuation-in-part of application No. 11/381,277, filed on May 2, 2006.

(51) Int. Cl. H04L 9/00

(52) U.S. Cl. 705/52

(57) ABSTRACT

One provides (102) a text-based document that is configured and arranged to elicit information regarding one or more persons regarding specific personal actions to be uniquely taken by such persons in specific response to a civilly-catastrophic event having occurred. One then uses (103) that text-based document to obtain such information and then provide (104) to such persons a resultant text-based document. This resultant text-based document comprises, at least in part, a combination of the aforementioned information and other generic information regarding specific personal actions to be generically taken by persons in specific response to particular civilly-catastrophic events having occurred. So configured and by these teachings, this resultant text-based document is available to such persons as a personal guide regarding specific personal actions to be taken in response to civilly-catastrophic events to thereby facilitate such persons taking appropriate helpful actions in such circumstances.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

the contents of which are fully incorporated herein by this reference.

### TECHNICAL FIELD

This invention relates generally to providing survival related services and more particularly to the proactive formulation of an event response plan.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or human-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provides some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and a niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum. On the one hand, many modern governments typically do little to proactively ensure the survival (let alone the comfort) of their citizens in the face of most civilly-catastrophic events. On the other hand, attempting to take responsible actions to reasonably ensure one's own safety and security can become, in and of itself, nearly a full-time avocation.

Consider, for example, the difficulties one faces when simply trying to formulate a comprehensive catastrophic event response plan. It can be difficult enough to educate oneself regarding the steps that should advisably be observed regarding any given civilly-catastrophic event. What one learns when making this effort, however, may or may not be useful (or even detrimental) when responding to a different category of civilly-catastrophic event. To illustrate, even when evacuating one's home comprises a centerpiece primary action to be taken when responding to numerous different civilly-catastrophic events, the details of those evacuation plans can differ considerably. What should be taken, how quickly one should evacuate, and where one should go next can all vary with the event.

Furthermore, simply having a comprehensive catastrophic event response plan may be insufficient in and of itself. When a particular group of individuals, such as a family, happen to be separated at the time of such an event, great uncertainties can arise with respect to what parts of such a plan are to be taken by whom and when. In addition, long distance communications may be at least temporarily inhibited during and following such an event and this can further complicate, frustrate, or even defeat the intent and purpose of such a plan as well as the ability of such a group to successfully reconstitute itself at a later time.

### BRIEF DESCRIPTION OF THE DRAWINGS

The above needs are at least partially met through provision of the document-based civilly-catastrophic event personal action guide facilitation method described in the following detailed description, particularly when studied in conjunction with the drawings, wherein:

FIG. 1 comprises a flow diagram as configured in accordance with various embodiments of the invention; and

FIG. 2 comprises a top plan schematic diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a text-based document that is configured and arranged to elicit information regarding one or more persons regarding specific personal actions to be uniquely taken by such persons in specific response to a civilly-catastrophic event having occurred. One then uses that text-based document to obtain such information and then provide to such persons a resultant text-based document. This resultant text-based document comprises, at least in part, a combination of the aforementioned information and other generic information regarding specific personal actions to be generically taken by persons in specific response to particular civilly-catastrophic events having occurred. So configured and by these teachings, this resultant text-based document is available to such persons as a personal reference guide regarding specific personal actions to be taken in response to civilly-catastrophic events to thereby facilitate such persons taking appropriate helpful actions in such circumstances.

By one approach the text-based document and/or the resultant text-based document comprise hardcopy artifacts and/or virtual documents. The text-based document by one approach includes user text-entry areas where the aforementioned information is received. Such user text-entry areas can be fully or partially blank by one approach. If desired, one or more of these user text-entry areas can have user-editable default information entries disposed therein. By one approach the text-based document provides questions and/or other information in association with such text-entry opportunities to lead the reviewer into considering personal and specific appropriate responses and actions that should be taken during a time of need. In many cases, it may be expected that such questions/information will be thought provoking, causing the reader to consider matters they have not likely considered in the past.

So configured, the resultant event response plan is both highly personal and customized to reflect the needs and/or opportunities as correspond to a given person or group of persons while also serving to highly leverage a comprehensive store of information regarding appropriate actions to take in different situations in a more generic sense. In addition, the process itself can help with better preparing an individual to actually respond more quickly in an emergency situation for having gone through the information elicitation process itself. In addition, these teachings are readily applied in a manner that tends to assure that a group of persons may act in virtual concert with one another even when communications have broken down or are otherwise unavailable and even when great uncertainty may exist regarding a given civilly-catastrophic event.

By one approach these teachings may be employed in conjunction with consideration-based private civil security subscriptions that are accepted from subscribers with respect to providing civilly-catastrophic event-based access to at least one life-sustaining resource. The nature of the subscribed-to resource can vary with the needs or requirements of a given application setting but may comprise one or more of a consumable necessity of human life, a non-consumable necessity of human life, shelter, transportation to effect the above-mentioned access, and/or rescue, to note but a few useful examples. By this approach the resultant text-based document can further include specific actions that will facilitate a given authorized beneficiary of such a subscription gaining access to the life-sustaining resource(s) of choice.

These steps are facilitated without dependency upon governmental oversight, participation, or control. Importantly, an individual can take important steps via these teachings to bring security into their lives without having to effectively become a full-time survivalist; such individuals can, in short, continue to enjoy their chosen vocations and standard of living knowing that, should a civilly-catastrophic event indeed be visited upon them, they will have access to a comprehensive yet highly personal and customized plan by which to respond to such an event.

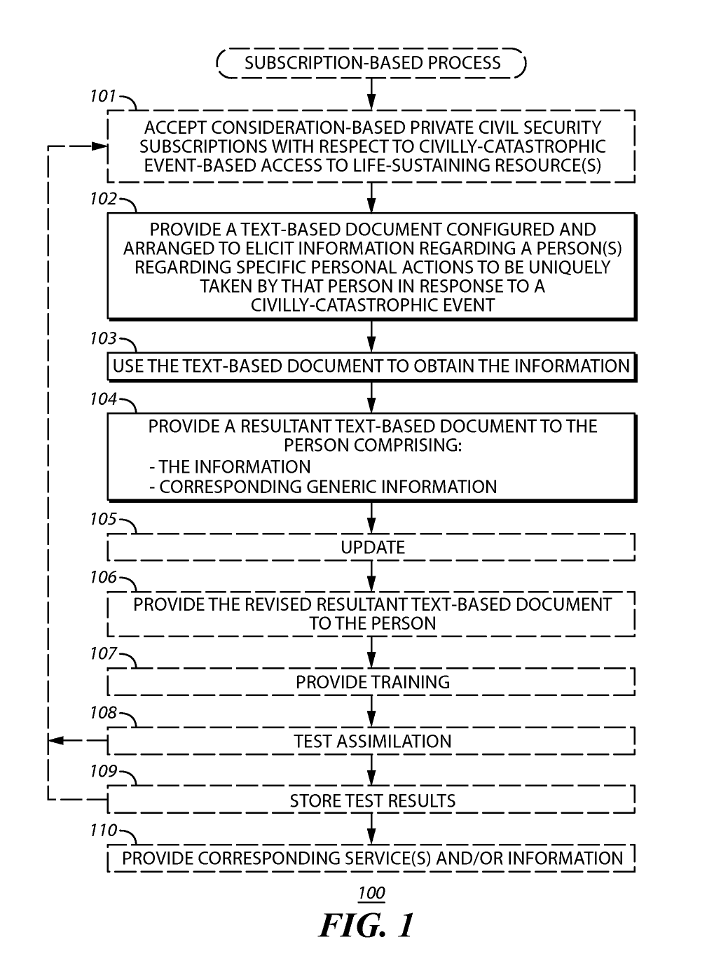

These and other benefits may become clearer upon making a thorough review and study of the following detailed description. Referring now to the drawings, and in particular to FIG. 1, these teachings may optionally encompass or otherwise accompany a subscription-based process. For example, this process 100 will accommodate the offer and acceptance 101 of consideration-based private civil security subscriptions from subscribers with respect to providing civilly-catastrophic event-based access to at least one life-sustaining resource such as, but not limited to, a life-sustaining shelter from threats presented by a civilly-catastrophic event, transport away from an area of substantially sudden civic upheaval, and/or a rescue service to come to an authorized beneficiary as corresponds to one of the subscriptions and move that authorized beneficiary away from a location of substantially sudden civil upheaval. In such a case, the steps and actions described below can also comprise, in whole or in part, an accoutrement of such a subscription.

By one approach, these subscriptions may be accepted by, for example, a for-profit business. By another approach a not-for-profit business (such as a membership-based entity) may be the appropriate entity to offer and accept such subscriptions. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers a payment on a month-by-month basis to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights in the at least one life-sustaining resource);

non-transferable rights of access (as may occur when the subscription, by its terms and conditions, prohibits transfer of the right of access to the at least one life-sustaining resource from a first named beneficiary to another);

transferable rights of access (as may occur when the subscription, by its terms and conditions, permits, conditional or unconditional transfer of the right of access to the at least one life-sustaining resource from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the at least one life-sustaining resource); and/or

non-ownership-based rights of access (as may occur when the subscription, by its terms and conditions, establishes the aforementioned right of access via, for example, a lease, rental, or borrowing construct).

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions may relate to providing access to one or more life-sustaining resources in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice.

As used herein, civilly-catastrophic event will be understood to refer to an event that substantially disrupts a society's infrastructure and ability to provide in ordinary course for the at least one life-sustaining resource that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well, unfortunately, as intentional acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

Regardless of whether a subscription-based process is used, this process 100 includes the step of providing 101 a text-based document. This text-based document is configured and arranged to elicit information regarding at least one person regarding specific personal actions to be uniquely taken by that person in specific response to a civilly-catastrophic event having occurred. An illustrative listing of such actions might include, but would certainly not be limited to:
an action to prepare a building (such as a home or business) to be at least temporarily abandoned by the at least one person (in order, for example, to secure that building against unauthorized access, damage due to any of a variety of influence and causes, and so forth);
an action to evacuate the at least one other person to another location (such as a public or private shelter, an evacuation staging area, and so forth);
an action to move to another location where the at least one person is to be joined by another predetermined person (such as a spouse or other family member, a business compatriot, a government co-worker, and so forth);
an action to intentionally increase a likelihood of later establishing communications with at least one other person (via, for example, a voice, video, and/or data link of choice);
an action to intentionally increase a likelihood that the at least one person will survive the civilly-catastrophic event (by identifying, for example, particular strengths, traits, knowledge, experience, weaknesses, disabilities, behavioral proclivities, and so forth as may influence their ability to survive one way or the other);
   to note but a few.

By one approach this text-based document can comprise, in whole or in part, a virtual version (such as a computer file, a web-based resource, and so forth, including but not limited to any of a wide variety of formats such as a relational database). By one approach this text-based document can comprise, in whole or in part, a hardcopy version.

By one approach this text-based document presents user text-entry areas that are interspersed with predetermined text. The user text-entry areas may comprise, for example, completely or substantially blank areas. So configured, a user can enter information by writing the information into such areas. If desired, user-editable default information entries can also be presented in conjunction with such user text-entry areas. The predetermined text, in turn, can comprise questions, corresponding data, and/or examples that are relevant to informing and guiding the user as to the formulation and entry of appropriate data in the user text-entry areas.

To illustrate, and not by way of limitation, consider the following simple example in this regard. A given portion of the text-based document as pertains to responding to the explosion of a nuclear weapon might read, at least in part, as follows (it will be appreciated that the blank user-text entry spaces are of an arbitrary size and number for this example for the sake of brevity and clarity):
What are the names and ages of all family members that reside at home? ______, ______, . . . ______
Identify any of these persons having a physical or mental disability and briefly state the nature of the disability. ______
Identify any of these persons that is likely to be away from the home on a scheduled basis (for example, at work, at school, at a volunteer activity, or the like) and provide information regarding that schedule along with the address where the person would likely be at the indicated times/dates. ______
Identify any of these persons having special medical needs (such as chronic prescriptions) and provide details regarding those needs. ______
What is the address of the home? ______
What is the address for your nearest radiation shelter, if any? ______
What is the address for any other radiation shelter to which you may have access? ______
Identify your vehicles as are likely to be available at the home and include a brief description of the type of vehicle, maximum occupancy, and any information that relates to its reliability, readiness, range, and off-road capability. ______
Identify any recreational vehicles that you have in addition to any that you have already identified above and include a brief description of the vehicle, maximum occupancy, and any information that relates to its reliability, readiness, range, off-road capability, accommodations, and the storage address for the vehicle. ______
Identify any irreplaceable objects in your home that you would wish to save and include some indication of their general size and weight along with their usual location within your home (You may, if you wish, list these objects in a prioritized order). ______
Identify any important (but replaceable) objects in your home that you would wish to save and include some indication of their general size and weight along with their usual location within your home (You may, if you wish, list these objects in a prioritized order). ______
Where is your home's main water valve located? ______
Where is your home's main gas valve located? ______
Where is your home's main electrical circuit breaker located? ______
Where would your pre-packed emergency provisions (food, medicine, clothing, batteries, water, and so forth) be located? ______

As mentioned above, one or more of these user-text entry areas can comprise, at least in part, a corresponding user-editable default information entry. For example, one of the above-presented exemplary questions could read instead as follows:
Identify any irreplaceable objects in your home that you would wish to save and include some indication of their general size and weight along with their usual location within your home (You may, if you wish, list these objects in a prioritized order). Family heirloom(s), keepsake jewelry, handmade items of great sentimental value, ______
   Instructions could be provided, for example, advising the user to strike any default information entries with which the user did not agree. Such default entries, when present, may be helpful to remind the user of particular information entries that they might otherwise forget and/or to elicit some other response that might otherwise not have been offered but for the suggestion of the default entry.

In the illustrative examples provided above, the text-based document is configured and arranged to elicit textual information. If desired, this can be supplemented through elicitation of graphic information as well where appropriate. As but one illustrative example in this regard, the text-based document may prompt provision of a photograph of the main gas valve for the respondent's home. Such a photograph could literally be pasted or otherwise placed into the text-based document. As another approach the photograph could be presented in digital form. For example, a sleeve could be provided in the text-based document to receive a photograph-bearing digital storage media of choice (such as a CDR). Other images could be solicited where the provision of such information might prove useful to formulating a corresponding response plan as described below.

As noted, this text-based document serves to elicit information regarding specific personal actions that can or should be taken by one or more specific persons when responding to a civilly-catastrophic event. This can comprise, if desired, developing an overall general response to be observed regardless of the nature of the civilly-catastrophic event. For example, the text-based document can serve to elicit information regarding specific personal actions to be taken in order to facilitate evacuation of this person (or persons) from, for example, their home. In many cases, however, this general approach may be unsatisfactory in at least some application settings.

For example, the speed by which one accomplishes such an evacuation can vary dramatically depending upon the category of civilly-catastrophic event being addressed. In some cases a very rapid evacuation may be essential while in other cases a more sedate and deliberate approach may be viable. As another example, in one case an evacuation may represent a very short term event (such as hours or only one day or so) while in other cases the evacuation may represent a longer term event (such as many days or even weeks or months). Such differences, in turn, can lead to significant differences with respect to the specific actions that may or should be reasonably taken under such circumstances.

Therefore, for many purposes, it may be preferable that the text-based document be configured and arranged to elicit information regarding specific personal actions to be uniquely taken by a given person (or persons) in specific response to any of a plurality of categorically different civilly-catastrophic events having occurred. Some illustrative event examples in this regard would include, but are not limited to:
a release of nuclear radiation event (including accidental, purposeful, and/or a natural and incidental release of such an agent);
a release of at least one dangerous biological agent event (including accidental, purposeful, and/or a natural and incidental release of such an agent);
a release of at least one dangerous chemical agent event (including accidental, purposeful, and/or a natural and incidental release of such an agent);
a severe weather event;
a severe geological event;
a severe widespread conflagration event;
an act of war event;
an act of terrorism event; and/or
a severe concussive event;
   to note but a few.

In such a case, the text-based document may have different discrete portions that each relate substantially only to a specific corresponding one of the categorically different civilly-catastrophic events to facilitate eliciting discrete information regarding specific personal actions to be uniquely taken by the aforementioned person with respect to each of the plurality of categorically different civilly-catastrophic events. By one approach, if desired, color can serve to aid with visually differentiating such discrete portions. For example, portions of the text-based document that deal with eliciting information regarding the formulation of a proper response to a nuclear radiation event can be associated with the color blue while portions that deal with eliciting similar information regarding a severe weather event can be associated with the color red. The pages themselves can be fully or only partially colored in the aforementioned manner to provide the desired indicia.

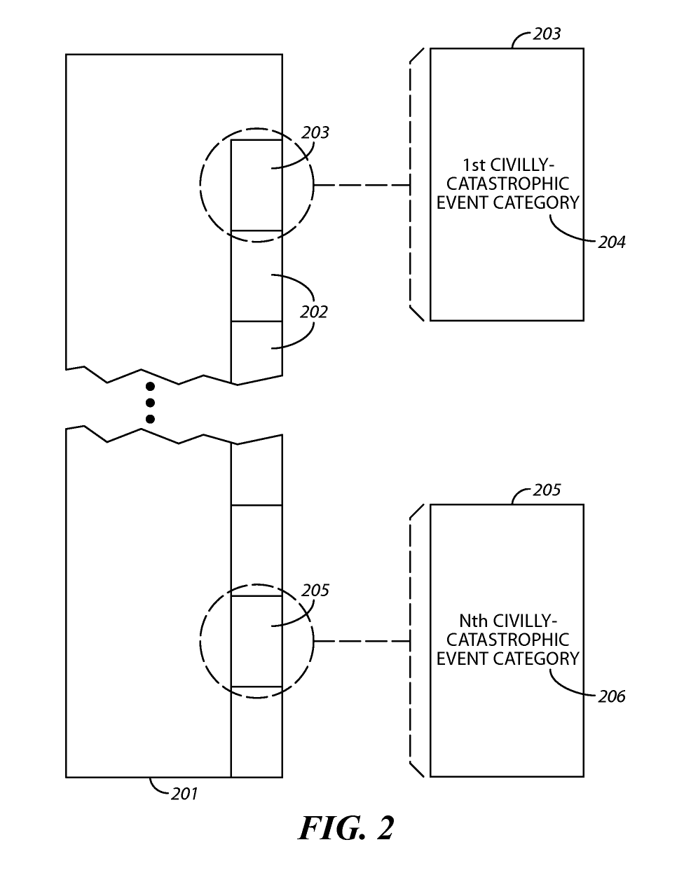

In lieu of color (or in combination therewith), exposed tabs can similarly serve to demark one such discrete portion of the text-based document from another. Referring momentarily to FIG. 2, such tabs 202 may extend outwardly from some or all of the pages of the text-based document 201. These tabs 202 may be colored to match a corresponding portion when employing color as a visual differentiator. In addition, or in lieu thereof, some or all of the tabs 202 may bear text that identifies, for example, a corresponding category of civilly-catastrophic event. For example, as illustrated, one such tab 203 can bear text 204 that identifies a first civilly-catastrophic event category while an Nth tab 205 can bear text 206 that identifies an Nth civilly-catastrophic event category.

As noted above, this text-based document can be configured and arranged to elicit the indicated information from and/or regarding one or more persons. By one approach such information is elicited as regards a plurality of people wherein the plurality of people are affiliated with one another with respect to at least one of:
a known family relationship (as versus an unknown relationship where two or more people have an unknown family relationship to one another);
a known business relationship (as when the plurality of people are employed by the same enterprise);
a known club relationship (as when the plurality of people are each a member of a given club such as a social club, a service club, a community-of-interest club, and so forth);
a known scholastic relationship (as when the plurality of people each shares a common alma mater, for example);
a known fraternal relationship (as when the plurality of people are each a member of a same fraternity or sorority);
a known governmental relationship (as when the plurality of people are each elected or appointed officials of a given governmental agency, body, or other similar entity); and/or
a known team relationship (as when the plurality of people are each a member
of a professional or amateur sports team or other competitive body);
   to note but a few.

Referring again to FIG. 1, this process 100 then provides for using 103 the text-based document to obtain the information of interest. When the text-based document comprises a hardcopy item, this can comprise, for example, filling in provided blank spaces using a pencil, pen, or other writing implement of choice. When the text-based document comprises a virtual item, such as a browser based web-accessible series of data-entry screens, this can comprise using a keyboard, voice recognition, or other data input mechanism and/or interface of choice. By one approach a single person provides the information of interest on behalf of a corresponding group such as their family. This, in turn, may or may not include input from other family members as may depend upon or otherwise reflect the needs and/or opportunities presented by a given application setting. By another approach, the text-based document may be specifically configured and arranged to prompt and/or require completion by different persons as comprise a given group or association of interest (such as a family, a business group, and the like).

It would also be possible, if desired, to provide for entry of such information via a third party of choice. For example, it may be useful in some settings to have an experienced party interview the at least one person and for that experienced party to make the actual informational entries in the text-based document. Such a person may be able to assist with imparting a better, faster, and/or more convenient understanding of the nature of the information being sought. Such an experienced party can comprise one or more individuals or might comprise, for example, a so-called software wizard and/or a supplemental guide resource of choice (such as an audio/video presentation that is provided via a DVD, streaming content via the Internet, and so forth).

This process 100 then provides 104 at least one resultant text-based document to the at least one person. This resultant text-based document comprises a combination of both the elicited information as well as other generic information regarding specific personal actions to be generically taken by persons in specific response to a civilly-catastrophic event having occurred. By one approach this comprises providing a hardcopy version of the resultant text-based document to the at least one person even when the original text-based document as served to elicit the information comprised a virtual document.

It would be possible to provide the resultant text-based document via a website, file transfer site, or other Internet (or Internet-like) mechanism, a thumbdrive (which will be understood to refer to a small digital memory media such as an SD card, a Flash card, or the like), and so forth. By one approach one's access and/or use of such a document may be governed by encryption, password protection, or the like. So configured, these approaches can serve to supplement the provision of a hardcopy version of the resultant text-based document to the at least one person and/or in lieu thereof. By one approach the recipient would be encouraged or otherwise instructed or required to print the resultant text-based document when accessing such sources in order to thereby achieve possession of a hardcopy version of the resultant text-based document.

As mentioned above, this step can comprise providing a hardcopy version of the resultant text-based document to the at least one person. As with the text-based document itself, the resultant text-based document can be parsed into segregated portions that treat, in turn, different categories of civilly-catastrophic events. And again, if desired, various approaches can be taken towards effecting and/or highlighting such segregation. For example, color-coding and/or tab usage as described above can be similarly applied with the resultant text-based document.

If desired, a hardcopy version of the resultant text-based document can comprise a standard softcover or hardcover bound or unbound document. For a variety of reasons, it will likely be preferred to provide a hardcover version that is at least somewhat more resistant to storage and/or anticipated usage than, say, a typical consumer-grade publication. For example, by one approach, one or more of the pages as comprise the resultant text-based document can be comprised of card stock that is at least sufficiently thick to resist or even prevent being folded during ordinary usage (unlike, for example, paper pages as comprise the typical consumer grade publication). If desired, a substantial majority (or even the entirety) of the resultant text-based document can be so comprised.

As another example, the resultant text-based document can be comprised of at least some pages that are comprised of a substantially heat-resistant material such that at least these pages will not burn when exposed to at least some temperatures that would cause paper pages to burn. Such heat-resistant material might comprise specially treated paper or paperlike material, metal or metal composite materials, thin ceramic sheets, and so forth. And as yet another example, if desired, one or more of the pages may be comprised of substantially waterproof material. Such waterproof material might comprise specially treated paper or paperlike material, metal or ceramic as mentioned above, or any of a wide variety of plastic substances.

The degree to which such measures are observed with respect to a given resultant text-based document can vary as a function, for example, of the particular risks being addressed by the document itself. For example, when the particular circumstances being faced by a particular person when facing a given category of civilly-catastrophic event present an increased risk that the resultant text-based document will be unduly exposed to fluids, it may be more appropriate to provide a resultant text-based document having at least the pages that present relatively critical information be comprised of water resistant and/or waterproof material. It will also be understood that the materials that comprise the resultant text-based document can vary as well with respect to the needs and requirements of the recipient.

By one approach, such hardcopy versions of the resultant text-based document can comprise unbound documents. For example, three ring binders (or the like) or other temporary page aggregation techniques can be used for this purpose. There may be some application settings where such an approach is preferred. In general, however, it is believed that a permanently bound document will better serve the intended purpose of the resultant text-based document. Such permanent binding can be realized using any of a variety of known binding techniques including, but not limited to, stitching, perfect binding, spiral binding, and saddle stitching, to note a few relevant examples. Such techniques are well known in the art and others are likely to be developed in the future. As these teachings are not particularly sensitive with respect to the selection of any particular approach in this regard, for the sake of brevity and clarity further elaboration in this regard will not be presented here.

As noted, this step accomplishes the provision of a resultant text-based document to at least the one person who provided the elicited information. In many cases, and particularly where that person is affiliated with others as described above, it may be appropriate to provide additional copies of the resultant text-based document to each such affiliated person. For example, when the affiliation comprises a family of four, this step will readily accommodate providing each of the four family members with a copy of the resultant text-based document.

By one approach, each such affiliated recipient can receive a customized version of the resultant text-based document. For example, only those actions that need be specifically taken by a given individual might be included in the document provided to that individual. In general, however, this likely comprises a less desirable approach. By providing each affiliated person with what essentially amounts to duplicate documents, each person then becomes informed with respect to the actions to be observed by each member of the affiliation. This, in addition to informing each person of their own appropriate helpful actions to take during a time of need, will further permit each person to effectively predict and/or correctly anticipate the specific personal actions being taken, or that will be taken, by each of the other affiliates.

This can be of critical importance in a scenario where: (a) at least one of the affiliates is separated from the other members of the affiliation at the time when a civilly-catastrophic event creates a need for action; and (b) ordinary communications (such as telephony, the Internet, and so forth) are temporarily or permanently disrupted. In particular, by knowing the specific actions being taken by other members of the affiliation, separated members can take corresponding actions that can reasonably be expected to lead to an eventual reunion between these parties.

It may also be advisable or useful in at least some application settings to provide a plurality of the resultant text-based documents to a given one of the persons of interest. This will permit such a person to place the resultant text-based documents in various places, such as their home, their place of business, and their vehicles (such as their automobiles, boats, aircraft, and so forth) or the like. This, in turn, can increase the likelihood that at least one of these resultant text-based document copies will be substantially readily available to this person in a time of need as corresponds to a civilly-catastrophic event. This may also prove useful in a stressful situation when human recall can become impaired or inaccurate, as at least one copy may be readily easy to locate and close at hand. In such a case, it may be useful to provide different hardcover versions of the resultant text-based document. For example, a relatively small version may be appropriate for placement in a vehicle while a full-size version may be appropriate for placement in a home setting.

By one approach, the resultant text-based document can simply comprise the text-based document itself when the elicited information has been entered therein. This might comprise, for example, a relatively low cost approach that is suitable for at least some application settings. This approach, however, would likely place considerable constraints with respect to how fully the unique circumstances of a given recipient will actually be understood, assimilated, and reflected in the resultant event response plan. In general, it may be a better approach to provide a resultant text-based document that incorporates the elicited information in a more fluid manner.

To again provide an illustrative but non-limiting example, a portion of a resultant text-based document as corresponds to correctly responding to a nuclear weapon explosion in a nearby city could provide for two separate home evacuation plans; one evacuation plan that requires only fifteen minutes and a second evacuation plan that requires only thirty minutes. The resultant text-based document could present threat detection and confirmation tests or criteria that could, in turn, be employed to select as between the two evacuation plans. Examples in this regard might include, for example:
an extremely bright flash of light;
an explosive noise;
loss of electrical power (and particularly when coincidental with a home generator that now will not start);
a mushroom-shaped cloud;
a confirming broadcast radio report;
an inoperative telephone landline; and
the sounding of municipal emergency sirens;
   to note but a few. By one approach, any one, two, or more of these events could serve as a trigger to evacuate with the particular trigger events, in combination and/or in view of their relative severity or strength serving to inform selection of a fifteen minute or a thirty minute evacuation plan.

These evacuation plans could differ with respect to whether a working spouse and/or school age children happened to be at home at the time of needing to effect the evacuation plan. A particular illustrative evacuation plan for responding to a nuclear explosion or other nuclear event when the working spouse is absent and the children are home might read in part as follows:
1) Taylor ingests a potassium iodine tablet from the supply located on the garage evacuation shelf.
2) Taylor provides potassium iodine tablets to Lisa and Fred.
3) Attempt to start the Rascal vehicle. If the Rascal fails to start, attempt to start the Raven vehicle. If both vehicles fail to start, turn to the Creation of a Hasty Radiation Fallout Shelter section. Close windows and switch vehicle off.
4) Place Lisa and Fred in backseat of the selected vehicle. Lisa is responsible to buckle both Fred and herself in.
5) Load five fuel jerry cans from garage rack into back of the selected vehicle.
6) Cover the loaded jerry cans with a moving blanket from the garage evacuation shelf.
7) Place the pre-packed evacuation bags hanging below the garage evacuation shelf into the back of the selected vehicle (Lisa's bag is provided to Lisa who removes the CB radio, switches it ON, and place it in the front seat of vehicle and who takes out three radiation dosimeters and attaches one to her chest area, one to Fred's chest area, and one in the front seat for Taylor).
8) Place pre-packed evacuation food bag from the garage evacuation shelf into the back of the selected vehicle.
9) Place the five gallon water jerry can in the back of the selected vehicle.
10) Place any currently needed medications in the vehicle.
11) Remove from the fireproof safe: passports, cash, jewelry.
12) Remove laptop from desk in den.
13) Lock home windows and doors.
14) Start vehicle with environmental control systems switched off; leave windows closed.
15) Attach radiation dosimeter to your chest and follow the predetermined evacuation path.

When sufficient time permits use of a thirty minute evacuation plan, for example, the aforementioned fifteen minute plan could be expanded to include additional actions. Illustrative examples might comprise:
16) Place Fluffy the household pet in the vehicle.
17) Place two arm loads of loose children's clothes in the vehicle.
18) Place two arm loads of loose adult clothes in the vehicle.
19) Place sterling silver from dining room hutch in the vehicle.
20) Turn the main gas valve in the garage off.
21) Place the family photo albums from the den in the vehicle.
22) Place the critical family documents from the two removable drawers in the fire proof file cabinet in the den in the vehicle.
23) Take a flashlight from the kitchen into the basement.
24) Turn the main water valve in the basement off.
25) Open the basement utility sink faucet.
26) Turn the main electrical circuit breaker in the basement off.
27) Etc.

In the examples provided above, the advice and instructions provided to the reader are textual in nature. It would also be possible to supplement such text with graphic content where appropriate. This could include the use of photographs that depict items or locations of interest as pertain specifically to the person or persons of interest including, but not limited to, photographs and other graphic content as may have been provided by the person when using the text-based document to provide their information.

As suggested earlier, the resultant text-based document can also provide for one or more steps and/or protocols to be used when affiliated members are absent and one seeks to re-establish contact. For example, when evacuation has removed the main family sufficiently distant from the nuclear event of concern, phone service and/or radio communications may again be possible. A corresponding plan under such circumstances may be for Taylor to attempt to contact Pat (the working spouse in the above example) at the top of every hour. When Taylor reaches voice mail for Pat, Taylor can be instructed to leave specific information such as a present location (road identification, mile marker, intersection, town, and so forth), identification of the vehicle that Taylor is driving, the present time and time zone for Taylor, remaining fuel supplies, and so forth.

In addition to providing specific evacuation routes, the resultant text-based document can provide other rules and protocols to govern choices. For example, when an uninformed choice must be made with respect to road surface preferences, a general direction in which to head when a predetermined route (or routes) are unavailable, refueling, rest stops, and so forth, specific preferences in this regard can be set forth by the resultant text-based document. Since, in this example, both Pay and Taylor will have access to the substantially same resultant text-based document, they both have an improved chance of tracking one another and locating one another even when long distance communications are, and remain, unavailable.

Over time, it is possible that the resultant text-based document will become out of date. This can occur as a result of changes with respect to the person and/or affiliated group of interest, changes with respect to the specific threats that need addressing, changes with respect to current resources and thinking as regards a best way to respond to particular civilly-catastrophic events, and so forth. In such a case, these teachings will readily accommodate the optional updating 105 of the resultant text-based document to include such new information regarding actions to be taken by persons in response to civilly-catastrophic events to provide a revised resultant text-based document. This revised resultant text-based document can then be provided 106, automatically or otherwise, to the person of interest.

Such an updating service can comprise a part, if desired, of the aforementioned subscription-based process This can comprise, for example, periodic scheduled reconsiderations of the person's particulars in this regard. Regardless, it may be useful in many application settings to provide each resultant text-based document (and each revision) with a version date. By one approach this version date is prominently displayed on and/or in the document. This, in turn, will facilitate assuring usage of a presently most-current version of the document.

These teachings will accommodate any of a wide variety of other steps as well. As one example, this process 100 can optionally provide for training 107 of the recipients of the resultant text-based document. More particularly, this training can comprise training regarding actions to be taken by the at least one person in response to a civilly-catastrophic event, which training supplements and/or instills the contents of the resultant text-based document. This can readily comprise customizing the training as a function, at least in part, of the elicited information. This, in turn, can result in training that is very specific with respect to the data provided and the choices that were made regarding specific personal actions to be uniquely taken by the at least one person in specific response to a civilly-catastrophic event having occurred. Such training can assume any useful form or modality including but not limited to e-learning, live instruction, and so forth.

These teachings will also optionally provide for testing 108 the at least one person with respect to their assimilation of the resultant text-based document, the training, or such other related topics as may be appropriate to consider. Again, such testing can assume any useful form or modality. This, in turn, can lead to optionally storing 109 the resultant test results to thereby provide a persisting acknowledgement that the at least one person has demonstrated at least a predetermined level of subject matter assimilation. The test results and/or this maintained test result record can itself serve to inform the aforementioned subscription-based approach if so desired. As but one example in this regard, the consideration assessed for a particular subscription can be varied to reflect the results of such testing. To illustrate, the fee charged for such a subscription may be reduced for authorized beneficiaries who have demonstrated a particular level of skill and understanding of their particular roles and responsibilities during a time of need.

As yet another example, these teachings will further optionally support the provision 110 of other corresponding services and/or information. To illustrate, this can comprise providing a communications service via, for example, a voicemail host, a bulletin board host, and/or an email host. In such a case, if desired, the resultant text-based document can include information regarding how to access and utilize such hosts such that the at least one person can utilize the host to re-establish contact with predetermined other persons upon the occurrence of a civilly-catastrophic event. As another example, this can include providing threat assessment information to the at least one person (via any communication vehicle of choice including but not limited to email, a hardcopy or virtual newsletter, a website, and so forth). Such information can serve to prompt particular anticipatory steps such as the stockpiling of particular commodities, the pre-placement of particular evacuation supplies, an adjustment with respect to ordinary daily behaviors, and so forth.

So configured, these teachings provide a powerful, economical, highly scalable, and readily leveraged mechanism by which a given individual or group of affiliated individuals can be provided with a well-informed yet personally customized series of actions to be taken in the event of any of a variety of different civilly-catastrophic events. These teachings also provide a realistic basis for facilitating the members of an affiliated group re-establishing contact with one another notwithstanding the short, medium, and/or long term impact of a given civilly-catastrophic event upon communications and the like.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a text-based document wherein the text-based document is configured and arranged to elicit information regarding at least one person regarding specific personal actions to be uniquely taken by the at least one person in specific response to a civilly-catastrophic event having occurred;
using the text-based document to obtain the information;
providing to the at least one person a resultant text-based document comprising a combination of:
the information; and
other generic information regarding specific personal actions to be generically taken by persons in specific response to a civilly-catastrophic event having occurred;
such that the resultant text-based document is available to the at least one person as a personal guide regarding specific personal actions to be taken by the at least one person in response to the civilly-catastrophic event to thereby facilitate the at least one person taking appropriate helpful actions in such circumstances.

2. The method of claim 1 wherein providing a text-based document wherein the text-based document is configured and arranged to elicit information comprises providing a text-based document having user text-entry areas interspersed with predetermined text.

3. The method of claim 2 wherein using the text-based document to obtain the information comprises receiving at least some of the information in at least some of the user-text entry areas.

4. The method of claim 2 wherein providing a text-based document having user text-entry areas interspersed with predetermined text comprises providing a text-based document having user text-entry areas wherein at least some of the user-text entry areas are substantially blank.

5. The method of claim 4 wherein providing a text-based document having user text-entry areas interspersed with predetermined text comprises providing a text-based document having user text-entry areas wherein at least some of the user-text entry areas are completely blank.

6. The method of claim 4 wherein providing a text-based document having user text-entry areas interspersed with predetermined text comprises providing a text-based document having user text-entry areas wherein at least substantially all of the user-text entry areas are substantially blank.

7. The method of claim 6 wherein providing a text-based document having user text-entry areas wherein at least substantially all of the user-text entry areas are substantially blank comprises providing a text-based document having user text-entry areas wherein all of the user-text entry areas are substantially blank.

8. The method of claim 2 wherein providing a text-based document having user text-entry areas interspersed with predetermined text comprises providing a text-based document wherein at least one of the user text-entry areas has a user-editable default information entry disposed therein.

9. The method of claim 8 wherein providing a text-based document wherein at least one of the user text-entry areas has a user-editable default information entry disposed therein comprises providing a text-based document wherein a plurality of the user text-entry areas has a user-editable default information entry disposed therein.

10. The method of claim 1 wherein providing a text-based document comprises providing a hardcopy version of the text-based document.

11. The method of claim 10 wherein providing a hardcopy version of the text-based document comprises providing a hardcopy version of the text-based document wherein the text-based document is configured and arranged to elicit information regarding at least one person regarding specific personal actions to be uniquely taken by the at least one person in specific response to any of a plurality of categorically different civilly-catastrophic events having occurred.

12. The method of claim 11 wherein the plurality of categorically different civilly-catastrophic events comprise, at least in part, at least one of:
a release of nuclear radiation event;
a release of at least one dangerous biological agent event;
a release of at least one dangerous chemical agent event;
a severe weather event;
a severe geological event;
a severe widespread conflagration event;
an act of war event;
an act of terrorism event;
a severe concussive event.

13. The method of claim 11 wherein providing a hardcopy version of the text-based document wherein the text-based document is configured and arranged to elicit information regarding at least one person regarding specific personal actions to be uniquely taken by the at least one person in specific response to any of a plurality of categorically different civilly-catastrophic events having occurred comprises providing a hardcopy version of the text-based document wherein different discrete portions of the text-based document each relates substantially only to a specific corresponding one of the plurality of categorically different civilly-catastrophic events to facilitate elicting discrete information regarding specific personal actions to be uniquely taken by the at least one person with respect to each of the plurality of categorically different civilly-catastrophic events.

14. The method of claim 13 wherein providing a hardcopy version of the text-based document wherein different discrete portions of the text-based document each relates substantially only to a specific corresponding one of the plurality of categorically different civilly-catastrophic events comprises providing a hardcopy version of the text-based document wherein at least some of the different discrete portions are differentiated from one another by corresponding exposed tabs.

15. The method of claim 14 wherein providing a hardcopy version of the text-based document wherein at least some of the different discrete portions are differentiated from one another by corresponding exposed tabs comprises providing a hardcopy version of the text-based document wherein at least some of the different discrete portions are differentiated from one another by corresponding exposed tabs that bear text that identifies a corresponding category of civilly-catastrophic event.

16. The method of claim 13 wherein providing a hardcopy version of the text-based document wherein different discrete portions of the text-based document each relates substantially only to a specific corresponding one of the plurality of categorically different civilly-catastrophic events comprises providing a hardcopy version of the text-based document wherein at least some of the different discrete portions are differentiated from one another by corresponding colors.

17. The method of claim 1 wherein providing a text-based document wherein the text-based document is configured and arranged to elicit information regarding at least one person regarding specific personal actions to be uniquely taken by the at least one person in specific response to a civilly-catastrophic event having occurred comprises providing a text-based document wherein the text-based document is configured and arranged to elicit information regarding a plurality of people regarding specific personal actions to be uniquely taken by each of the plurality of people in specific response to a civilly-catastrophic event having occurred.

18. The method of claim 17 wherein providing a text-based document wherein the text-based document is configured and arranged to elicit information regarding a plurality of people regarding specific personal actions to be uniquely taken by each of the plurality of people in specific response to a civilly-catastrophic event having occurred comprises providing a text-based document wherein the text-based document is configured and arranged to elicit information regarding a plurality of people wherein the plurality of people are affiliated with one another with respect to at least one of:
a known family relationship;
a known business relationship;
a known club relationship;
a known scholastic relationship;
a known fraternal relationship;
a known governmental relationship;
a known team relationship.

19. The method of claim 17 wherein providing to the at least one person a resultant text-based document comprising a combination of the information and other generic information regarding specific personal actions to be generically taken by persons in specific response to a civilly-catastrophic event having occurred comprises providing to each of the plurality of people an individual copy of the resultant text-based document;
such that the resultant text-based document is available to each of the plurality of people as a personal guide regarding specific personal actions to be taken by each of the plurality of people in response to the civilly-catastrophic event to thereby facilitate the plurality of people each taking appropriate helpful actions in such circumstances and further to facilitate correct anticipation of specific personal actions to be taken by a given one of the plurality of people by others of the plurality of people.

20. The method of claim 1 wherein providing a text-based document comprises providing a virtual version of the text-based document.

21. The method of claim 1 wherein providing to the at least one person a resultant text-based document comprising providing to the at least one person the text-based document having the information entered therein.

22. The method of claim 1 wherein providing to the at least one person a resultant text-based document comprises providing to the at least one person a resultant text-based document wherein at least a substantial majority of pages are comprised of at least a thick card stock that resists being folded during ordinary usage.

23. The method of claim 1 wherein providing to the at least one person a resultant text-based document comprises providing to the at least one person a resultant text-based document wherein at least a substantial majority of pages are comprised of substantially waterproof material.

24. The method of claim 1 wherein providing to the at least one person a resultant text-based document comprises providing to the at least one person a resultant text-based document wherein at least some pages are comprised of substantially heat-resistant material such that the at least some pages will not burn when exposed to at least some temperatures that would cause paper pages to burn.

25. The method of claim 1 wherein providing to the at least one person a resultant text-based document comprises providing to the at least one person a resultant text-based document wherein at least a substantial majority of pages are permanently bound together.

26. The method of claim 1 wherein the information to be elicited comprises, at least in part, graphic information.

27. The method of claim 1 wherein the generic information comprises, at least in part, graphic information.

28. The method of claim 1 wherein at least one of the specific personal actions comprises at least one of:
an action to prepare a building to be at least temporarily abandoned by the at least one person;
an action to protect a structure;
an action to evacuate the at least one person to another location;
an action to move to another location where the at least one person is to be joined by another predetermined person;
an action to intentionally increase a likelihood of later establishing communications with at least one other person;
an action to intentionally increase a likelihood that the at least one person will survive the civilly-catastrophic event.

29. The method of claim 1 wherein providing to the at least one person a resultant text-based document comprises providing a plurality of the resultant text-based documents to the at least one person such that the at least one person can place the resultant text-based documents in various places, such as their home, their place of business, and their vehicles, to increase a likelihood that at least one of the resultant text-based documents will be substantially readily available to the at least one person in a time of need as corresponds to a civilly-catastrophic event.

30. The method of claim 1 wherein providing to the at least one person a resultant text-based document comprises providing access to the resultant text-based document via a website.

31. The method of claim 30 wherein providing access to the resultant text-based document via a website comprises providing access to the resultant text-based document via a password-protected website.

32. The method of claim 1 wherein providing to the at least one person a resultant text-based document comprises providing a resultant text-based document that is stored within a thumbdrive.

33. The method of claim 1 wherein providing to the at least one person a resultant text-based document comprises providing to the at least one person a resultant text-based document having a version date prominently displayed thereon to facilitate the at least one person assuring use of a presently most-current resultant text-based document.

34. The method of claim 1 further comprising:
accepting consideration-based private civil security subscriptions from subscribers with respect to providing civilly-catastrophic event-based access to at least one life-sustaining resource;
and wherein providing a text-based document, using the text-based document, and providing to the at least one person a resultant text-based document occurs as a function, at least in part, of accepting the consideration-based private civil security subscriptions.

35. The method of claim 34 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

36. The method of claim 34 wherein the at least one life-sustaining resource comprises at least one of:
a life-sustaining shelter from threats presented by a civilly-catastrophic event;
transport away from an area of substantially sudden civic upheaval;
a rescue service to come to an authorized beneficiary as corresponds to one of the subscriptions and move the authorized beneficiary away from a location of substantially sudden civil upheaval.

37. The method of claim 34 further comprising:
updating the resultant text-based document to include new information regarding actions to be taken by persons in response to a civilly-catastrophic event to provide a revised resultant text-based document;
automatically providing to the at least one person the revised resultant text-based document.

38. The method of claim 37 wherein automatically providing to the at least one person the revised resultant text-based document comprises automatically providing to the at least one person the revised resultant text-based document as a function, at least in part, of one of the consideration-based private civil security subscriptions.

39. The method of claim 1 further comprising:
providing training to the at least one person regarding actions to be taken by the at least one person in response to a civilly-catastrophic event, which training is in addition to provision of the resultant text-based document.

40. The method of claim 39 further comprising:
customizing the training as a function, at least in part, of the information such that the training provided to the at least one person reflects choices that were made regarding specific personal actions to be uniquely taken by the at least one person in specific response to a civilly-catastrophic event having occurred.

41. The method of claim 1 further comprising:
testing the at least one person with respect to their assimilation of the resultant text-catastrophic based document.

42. The method of claim 41 further comprising:
providing a persisting acknowledgement of the at least one person having demonstrated at least a predetermined level of the assimilation of the resultant text-based document.

43. The method of claim 42 further comprising:
maintaining a record of which persons have demonstrated at least the predetermined level of the assimilation of the resultant text-based document.

44. The method of claim 41 further comprising:
accepting consideration-based private civil security subscriptions from subscribers with respect to providing civilly-catastrophic event-based access to at least one life-sustaining resource wherein the consideration as corresponds to a subscription for the at least one person comprises a function, at least in part, of the testing.

45. The method of claim 1 further comprising:
providing a voicemail host;
and wherein the resultant text-based document comprises, at least in part, information regarding how to access and utilize the voicemail host such that the at least one person can utilize the voicemail host to re-establish contact with predetermined other persons upon the occurrence of a civilly-catastrophic event.

46. The method of claim 1 further comprising:
providing threat assessment information to the at least one person.

47. The method of claim 46 wherein providing threat assessment information to the at least one person comprises providing threat assessment information via at least one of:
email;
a newsletter;
a website.

48. The method of claim 1 further comprising:
providing an email host;
and wherein the resultant text-based document comprises, at least in part, information regarding how to access and utilize the email host such that the at least one person can utilize the email host to re-establish contact with predetermined other persons upon the occurrence of a civilly-catastrophic event.
